(19) United States
(12) Patent Application Publication
(10) Pub. No.: US 2005/0258935 A1
(43) Pub. Date: Nov. 24, 2005

(54) Manual override apparatus and method for an automated secure area entry access system

(76) Inventors: Wayne C. Hom, Rancho Santa Margarita, CA (US); Alex Parsadayan, Lake Forest, CA (US)

Correspondence Address: FITCH, EVEN, TABIN & FLANNERY, 120 SO. LASALLE STREET, SUITE 1600, CHICAGO, IL, 60603-3406, US

(21) Appl. No.: 10/285,767

(22) Filed: Nov. 1, 2002

Related U.S. Application Data
(63) Continuation of application No. 09/770,827, filed on Jan. 26, 2001, now abandoned.

(51) Int. Cl. G05B 19/00

(52) U.S. Cl. 340/5.62; 340/5.64; 340/5.71; 49/25

(57) ABSTRACT

A manual override device is disclosed for use with an automatic transponder system. This system has the capability of detecting errors in the operation of the system, and then for allowing for a manual override to initiate operation of a security gate when such is necessary.

This application is a continuation of U.S. patent application Ser. No. 09/770,827 filed on Jan. 26, 2001

### FIELD OF THE INVENTION

The present invention relates to identification and access systems. More particularly it relates to vehicle identifications and access systems to allow entry into a secure area.

### BACKGROUND OF THE INVENTION

There is a general need for vehicle identification systems for a multitude of applications such as controlling vehicular access in and out of parking structures, monitoring vehicular movement from one location to another, collecting tolls such as that found on the California toll road system, and restricting vehicular access to gated communities. Generally, systems such as AMTEK (used on the toll roads) or others are subject to malfunction due to RF noise interference, improperly installed equipment, or other factors that can prevent the vehicular identification transceiver from properly identifying the vehicle tag. The vehicle tag generally is a transponder that responds to a signal from the identification transceiver. Identification occurs when the vehicle is detected within a zone of detection.

When used to restrict access to a gated community or other limited access area the identification transceiver is located at and controls a gate opening and closing mechanism at an entry point into the restricted access area. The transceiver is connected to a vehicle detection system that, when operating properly, upon sensing the presence of a vehicle within a zone of detection in the area around the gate prompts the transceiver to broadcast a signal. Upon receipt of this broadcast signal by the transponder unit on the vehicle the transponder generates and broadcasts an encoded signal. Upon receipt by the transceiver of the encoded signal and identifying it as a valid code the transceiver authorizes the opening of the gate to allow entry of the vehicle into the restricted access area. However, as noted above these systems can malfunction for a variety of reasons including radio frequency interference, poor installation etc. Thus, many systems have to provide for a backup such as a live guard at the gated entry point to over-ride the system in the event it malfunctions. In the event there is no backup provision, the vehicle is forced to exit the entry point and retry to enter to re-trigger the system in an attempt to force the system to function properly. If this tactic fails the only option left is usually to call for assistance or forego entry if such assistance is not available and a 24 hour guard is not present.

Consequently, there exists a need for a system that can, provide for error free vehicle identification without relying on either a 24 hour guard system or other cumbersome and costly backup system. An identification and entry system that can be easily integrated into existing systems without the need for undue expense and modification of these systems.

### SUMMARY

Thus, it is an objective of the present invention to provide an economical, easily used and effective process and system that will provide for error free vehicle identification and that will include the ability to quickly, easily and economically allow for correction of errors in the operation of the identification system. It is a further object to provide an error corrections system that is easy to manufacture and integrate into existing systems without undue cost and expense.

The present invention accomplishes these and other objectives by providing a secure area entry system that includes a) a movable barrier; b) an active detection device that controls the opening and closing of said entry barrier; c) a transponder which when detected by said active detection device within a zone of detection opens said barrier to allow access; and d) wherein said transponder has a manual override apparatus which upon activation sends a signal to the active detection device to open said barrier so that when said active detection device fails to detect the presence of said transponder in said zone of detection said barrier can be opened by sending the signal with said manual override apparatus. In another aspect of the system it provides a transponder with a button on it such that when the button is depressed said transponder broadcasts the signal to the active detection device.

In another aspect of the invention it provides a method for overriding a malfunctioning secure area entry system, that includes the steps of: a) detecting a vehicle at a limited access area entry port; b) generating an interrogation signal; c) generating an identification signal by the vehicle upon receipt of the interrogation signal; d) analyzing the identification signal to determine if it has a code that allows the vehicle to have access to the limited access area; and e) allowing a person in the vehicle to resend the identification signal if the vehicle does not obtain access to thereby reinitiate the step of analyzing the identification signal to determine if it has a code that will allow the vehicle to have access to the limited access area.

### BRIEF DESCRIPTION OF THE DRAWINGS

The invention will be better understood by an examination of the following description, together with the accompanying drawings, in which:

FIG. 1 is a perspective view of one environment in which the present invention will work;

FIG. 2 is a schematic view of the major components of the system of the present invention in the environment in which they will function;

FIG. 3 is a side view of a transponder that incorporates the present invention;

FIG. 4 is a top view of the transponder depicted in FIG. 3;

FIG. 5 is a schematic block diagram of the major functional components of a transponder incorporating a preferred embodiment of the present invention;

FIG. 6 is a schematic block diagram of the major functional components of the transceiver interrogator detection device and gate opening mechanism; and

FIG. 7 is a flow chart of the operation of the present invention in the context of an automated system.

### DETAILED DESCRIPTION OF THE PREFERRED EMBODIMENT

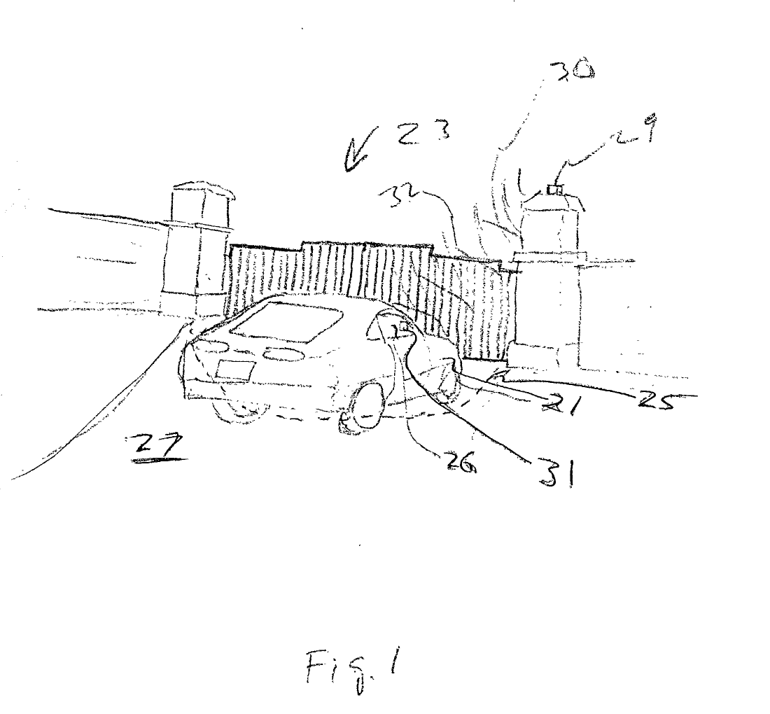

The present invention works with the typical vehicle detection systems used in gated communities. Such systems are designed to automatically determine when a vehicle at a gated entrance into the community is authorized to enter the restricted access area and open the gate to allow the vehicle to enter. FIG. 1 provides a prospective view of the major components of the system. A vehicle 21 upon reaching an entrance gate 23 of a gated community moves into the range of detection of a sensor 25. The sensor 25, in this case, is embedded in roadway 27. The sensor 25 connects through appropriate circuitry to a transceiver interrogator unit 29. Thus, when a vehicle 21 moves into rage of sensor 25 located under the road 27 it generates a signal that activates the transceiver interrogator unit 29 that in turn broadcasts a radio frequency signal 30. Radio frequency signal 30 is received by a transponder 31 located on vehicle 21, generally on the windshield 26 of the vehicle. Upon receipt of the signal generated by transceiver interrogator unit 29, transponder 31 generates its own encoded radio frequency signal 32 that is received by the transceiver interrogator 29. The transceiver interrogator unit 29 has appropriate circuitry to process the signal 32 received from transponder 31 and determine if the signal 32 from transponder 31 has a code of a vehicle authorized to enter the restricted area. If the transceiver interrogator unit 29 determines that it has received a code of an authorized vehicle it then signals a gate opening mechanism to open the gate 23 and allow the vehicle 21 to enter.

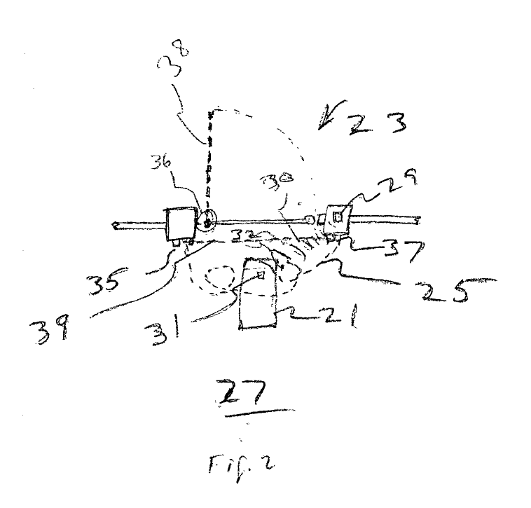

FIG. 2 provides an overhead schematic diagram of the system described above. FIG. 2 also depicts an alternative detection device, a laser beam generator 35 and receiver 37. The laser detections system works such that when a vehicle 21 arrives at gate 23 and moves to a position in front of the closed gate it blocks transmission of laser beam 39 from laser 35 to receiver 37 which in turn prompts transceiver 29 to generate its activation signal 30 that in turn is received by transponder 31. Transponder 31 generates its signal in response and as noted if upon receipt transceiver interrogator unit 29 determines it has received a correct authorization code it initiates opening of the movable portion 38 of the gate 23. In addition to the vehicle loop detector 25 and optical beam 35 and 37 mentioned above any other proximity sensor capable of detecting a vehicle can be used. The RF signals exchanged between the transceiver and transponder can be simple ‘continuous wave’ (CW) or modulated signals.

The systems described above have a tendency to malfunction for a variety of reasons. The detection loop systems 25 quite often detect the presence of the vehicle 25 by the changes in the local magnetic field created by the presence of a vehicle directly over it. However, if some other metal structure is in the area or some other cause exists to change the nature of the local magnetic field, detection system 25 may not function properly and thus not properly activate transceiver interrogator unit 29. Additionally, there may be some type of transient or permanent radio frequency interference in the local area that causes the system to malfunction. Such interference can be with the detection unit or interference with transmissions between the transceiver interrogator and transponder. When the system malfunctions and a vehicle carrying a transponder does not trigger the system properly the driver often has to back up and re-approach the gate in attempt to properly trigger the system. If this does not work then he or she is unable to enter unless there is someone present to open the gate for him. Most gated communities as a solution to this problem usually have a 24 hour guard located at one of the entries into the community who can initiate opening of the gate.

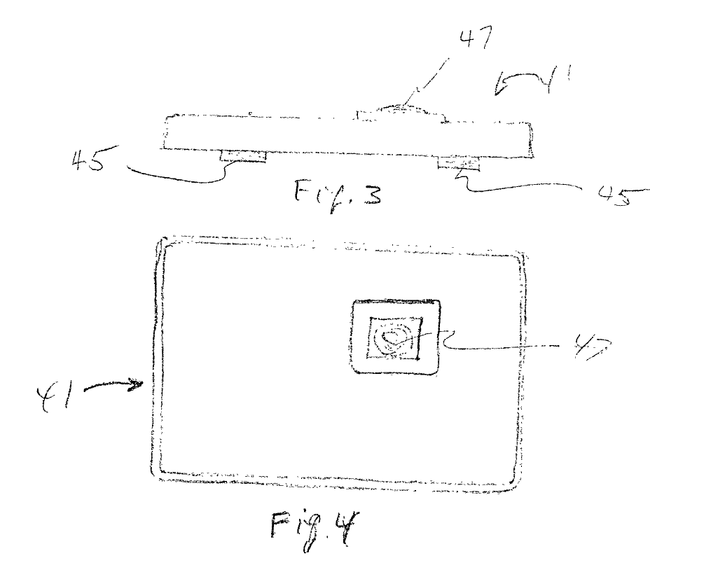

The present invention overcomes the problems of the current art by providing an override mechanism in the transponder unit that will allow the driver of a vehicle to initiate generation of the coded signal by the transponder. Thus, when the vehicle detection system malfunctions and the transceiver interrogator does not generate a signal to trigger the transponder, the driver can use the over ride system to do it. FIGS. 3 and 4 provide a side view and a top view respectively of a transponder unit 41 that includes the override mechanism of the present invention. The transponder unit 41 depicted in FIG. 3 and FIG. 4 typically has very compact dimensions of approximately three quarters of an inch thick by about three to three and a half inches long and a little over two to two and a third inches wide. The transponder 41 in a preferred embodiment depicted in FIG. 3 attaches to the windshield of a vehicle with adhesive strips 45. Generally the transponder is positioned in the lower left or right corner of the windshield or ideally on front windshield behind the review mirror of the vehicle at which position it is out of sight but easily accessible.

The actual override mechanism consists of a button 47 that upon depression prompts transponder 41 to transmit access signal 32 mentioned above and illustrated in FIGS. 1 and 2. Thus, when a driver of a vehicle arrives at the front gate of a gated community and for some reason the vehicle presence detection system as mentioned above fails to detect the presence of the vehicle and prompt transceiver interrogator unit 29 to generate a signal to interrogate transponder 41 the driver simply has to reach over to transponder 41 depress button 47 whereupon transponder 41 generates and transmits the necessary signal. The signal 32 is then detected by transceiver interrogator unit 29, which upon identifying the signal as one from an authorized vehicle by confirming it has a valid access code sends a gate open signal to the gate opening mechanism 36 (FIG. 2) to open the movable portion 38 of gate 23 and allow the vehicle to enter.

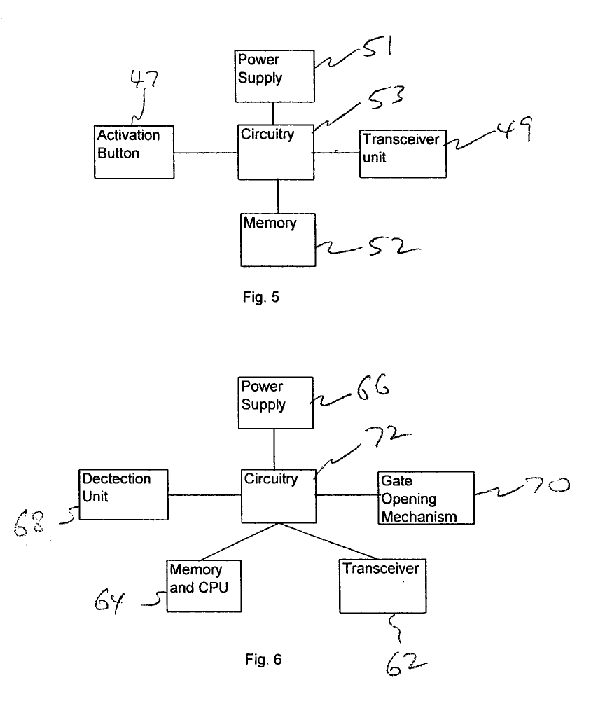

Naturally, transponder 41 has appropriate micro-circuitry and related electronic devices to function as described. Among the components as depicted in schematic diagram FIG. 5 transponder 41 typically would have are its own transceiver unit 49, a stand alone micro power supply 51, memory 52 of some kind to store the access code and any other programming the unit may need to function, circuitry 53 to appropriately interconnect the functional parts as well as override button 47. Naturally, additional components could or may be added and a wide variety of different configurations could be used and the same result achieved.

At a minimum transceiver interrogator unit 29, detection unit 25 and the gate opening mechanism will include the functional parts depicted in FIG. 6. These consist of a transceiver 62 a CPU with memory 64, a power supply 66, a detection unit 68, the gate operating mechanism 70 and circuitry 72 to appropriately interconnect all of these devices to properly function together. These are only the basic units necessary and any number of different configurations can be used without departing from the spirit of the present invention.

Radio frequency interference can also interfere with the radio signals exchanged between the transceiver interrogator and the transponder. In such situations even though the detector may properly detect the vehicle and send the appropriate activation signal because of radio frequency interference the system still might not determine the vehicle has the appropriate authorization code and admit the vehicle. In these situations the override button will allow the driver of the vehicle to resend the encoded signal and thus successfully open the gate without having to back up and drive forward to trigger the detection mechanism again.

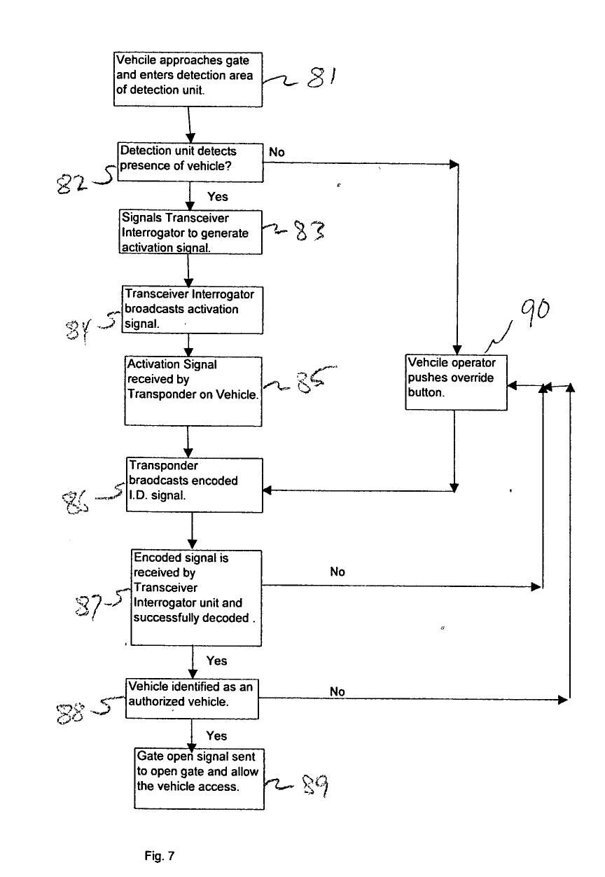

FIG. 7 provides a flow chart of a preferred method or process of the system that incorporates the present invention. If the entry system is functioning properly upon the approach of a vehicle and its entry into the detection area of the detection device the vehicle is detected 81. Upon detecting the vehicle 82 the detection unit signals the transceiver interrogator to generate an activation signal 83. The transceiver interrogator then broadcasts an activation signal 84. The activation signal is received by the transponder on the vehicle 85. The transponder then broadcasts the encoded signal 86. The encoded signal is received by the transceiver interrogator and if successfully decoded 87 the vehicle is identified 88. Finally, the gate opening mechanism once activated by a gate open signal allows the vehicle to have access to the restricted area 89. As note above sometimes the detection device does not detect the presence of the vehicle 82 and if this is the case the vehicle operator can push the override button 90 on the transponder which in turn prompts the transponder to broadcast the encoded signal 86. If the encoded signal is successfully received and decoded at step 87 and 88 step 89 follows with the gate opening.

Additionally, if at step 87 the encoded signal is not received properly, the vehicle operator can push the override button and again initiate the final sequence of steps 86, 87, 88 and 89. Also, if the signal is received but the code has some how become scrambled due to radio frequency interference or for some other reason and it is not been properly identified at step 88 then the vehicle operator can push override button 90 to initiate the final steps of 86, 87, 88 and 89. Thus, the override button gives the vehicle operator control over the gate opening system to the extent that he or she can easily override the automated system when it fails to operate properly, and without undue effort or frustration assist the system in overcoming the difficulties it is experiencing. These problems as noted above can be from a variety of sources.

Those of ordinary skill in the art, once they have perused this specification and understand the concepts of the present invention should be able to practice the concepts of the present invention and implement it without undue experimentation. Although the preferred embodiment of the present invention discuss use of the invention is a system used to allow entry of motor vehicles, such as cars, trucks etc. the system can easily be extended to other secure area entry systems that rely on a similar system.

While the invention has been particularly shown and described with reference to a preferred embodiment thereof, it will be understood by those skilled in the art that various changes in form and detail may be made to it without departing from the spirit and scope of the invention.

1. A manual override apparatus for a secure area entry access system, the secure area entry access system having a movable barrier controlled by an active detection device which upon detection of a vehicle in a zone of detection of a loop detector generates an interrogation signal which received by a transponder on the vehicle broadcasts an identifying reply signal that upon receipt and verification of accepted identification by the active detection device opens the entry barrier, said manual override apparatus comprising:
a mechanism on said transponder responsive to manual manipulation and which upon manual manipulation sends the identifying reply signal to the active detection device to cause the active detection device upon verification of accepted identify to open the barrier and allow access to the secure area so that when the active detection device fails to generate an interrogation signal when the vehicle is in the zone of detection of the loop detector, the transponder can broadcast the identifying reply signal to the active detection device.

2. The manual override system of claim 1 wherein said transponder responsive to manual manipulation is a transponder with a button on it wherein when the button is depressed said transponder broadcasts said signal to said active detection device.

3. The manual override apparatus for a secure area entry access system, the secure area entry access system having a movable barrier controlled by an active detection device which upon detection of a transponder within an area of detection of a loop detector opens the entry barrier, said manual entry apparatus comprising:
a mechanism on said transponder responsive to manual manipulation and which upon manual manipulation sends a signal to the active detection device to cause the active detection device to open barrier to open the barrier and allow access to the secure area so that when the active detection device fails to detect the transponder within the area of detection of the loop detector said transponder can signal the active detection device to open the barrier and allow access.

4. The manual override system of claim 3 wherein the system is used to allow a vehicle to enter the secure area.

5. A secure area entry system comprising:
a) a movable barrier;
b) a loop detector:
c) an active detection device coupled to the loop detector that controls the opening and closing of said entry barrier;
d) a transponder which when detected by said active detection device within a zone of detection of the loop detector opens said barrier to allow access; and
e) wherein said transponder has a manual override apparatus which upon activation sends a signal to the active detection device to open said barrier so that when said active detection device fails to detect the presence of said transponder in said zone of detection of the loop detector, said barrier can be opened by sending the signal with said manual override apparatus.

6. The manual override system of claim 5 wherein the system is used to allow a vehicle to enter the secure area.

7. The secure area entry system of claim 5 said transponder responsive to manual manipulation is a transponder with a button on it wherein when the button is depressed said transponder broadcasts said signal to said active detection device.

8. A method for overriding a malfunctioning secure area entry system, comprising the steps of:
a) detecting a vehicle at a limited access area entry port using a loop detector;
b) generating an interrogation signal;
c) generating an identification signal by the vehicle upon receipt of the interrogation signal;
d) analyzing the identification signal to determine if it has a code that allows the vehicle to have access to the limited access area; and
e) allowing a person in the vehicle to resend the identification signal if the vehicle does not obtain access to thereby reinitiate the step of analyzing the identification signal to determine if it has a code that will allow the vehicle to have access to the limited access area.

9. A secure area entry system comprising:
a) a movable barrier to restrict access into a secure area;
b) an active detection device that controls the opening and closing of said entry barrier and wherein said active detection device detects the presence of a vehicle in a zone of detection of a loop detector and generates an interrogation signal;
c) a transponder which when positioned on the vehicle will upon receipt of an interrogation signal broadcast an identification signal which when detected by said active detection device opens said barrier to allow access to the secure area; and
d) wherein said transponder has a manual override apparatus which upon activation sends said identification signal to the active detection device to initiate the opening of said barrier so that when said active detection device fails to detect the presence of said transponder in said zone of detection of the loop detector said barrier can be opened by sending said identification signal with said manual override apparatus.

10. The secure area entry system of claim 9 wherein said identification signal has a unique code which upon receipt and recognition by the active detection device allows access to the secure area.
